(19) United States
(12) Patent Application Publication
(10) Pub. No.: US 2026/0187642 A1
(43) Pub. Date: Jul. 2, 2026

(54) FRAUD DETECTION FOR TREASURY CHECKS

(71) Applicant: Early Warning Services, LLC, Scottsdale, AZ (US)

(72) Inventors: Tushar Agarwal, Scottsdale, AZ (US); Dhaval Bhatt, Scottsdale, AZ (US); Kathy Carlson, Scottsdale, AZ (US); Syed Badar, Scottsdale, AZ (US); Ganeshkumar Venkatesan, Scottsdale, AZ (US)

(73) Assignee: Early Warning Services, LLC, Scottsdale, AZ (US)

(21) Appl. No.: 19/551,968

(22) Filed: Feb. 27, 2026

Related U.S. Application Data
(63) Continuation-in-part of application No. 18/885,096, filed on Sep. 13, 2024.
(60) Provisional application No. 63/689,432, filed on Aug. 30, 2024.

(51) Int. Cl. G06Q 20/40; G06Q 20/04

(52) U.S. Cl. CPC G06Q 20/4016; G06Q 20/042

(57) ABSTRACT

A risk assessment system may include one or more processors and a memory having instructions stored thereon that, when executed by the one or more processors, cause the one or more processors to receive check information associated with a treasury check from a receiving institution. The check information includes a first payee name, a check number, an amount, and a routing number. The instructions cause the processors to send the check information to an issuing treasury institution and to receive, from the treasury institution, a second payee name. The second payee name was printed on the check by the treasury institution. The instructions cause the processors to determine whether the check has already been redeemed at another institution. The instructions cause the processors to provide a response to the receiving institution, the response including the second payee name or an indication of whether the first and second payee name match.

### CROSS-REFERENCE TO RELATED APPLICATIONS

This application is a continuation-in-part of U.S. application Ser. No. 18/885,096, filed Sep. 13, 2024, which claims the benefit of U.S. Provisional Application Ser. No. 63/689,432, filed Aug. 30, 2024, entitled “FRAUD DETECTION FOR TREASURY CHECKS”, the disclosures of which are incorporated by reference herein in their entirety.

### BACKGROUND OF THE INVENTION

Banks have seen an increase in bad actors forging treasury checks issued via check washing, with such fraud being estimated to cost U.S. banks over $300 million in losses per year. To perpetrate fraud, bad actors open a new account with a different bank using real or first party synthetic credentials, wash a stolen check to remove the original payee name, and submit the stolen check with their own real or fictitious name in place of the original payee name. If successful, the funds are withdrawn, leaving the bank with a non-negotiable check.

Additionally, with conventional systems it is unfeasible for financial institutions to verify whether a particular check has been redeemed at another financial institution, especially with the prevalence of electronic deposits. For example, a financial institution at which a check was presented for redemption would need to send inquiries to thousands of different financial institutions to verify that the check has not already been deposited. This would need to be repeated for every check received and would result in an overwhelming amount of network traffic that would not be supportable using current network infrastructure. The verification of duplicate negotiable instruments across disparate, unconnected financial institution servers presents a technical computer network routing problem. In a conventional decentralized network topology, verifying a single check requires a receiving financial institution server to broadcast individual network inquiry packets to thousands of remote financial institution servers. This creates an O(n) or O(N²) communication burden that consumes excessive network bandwidth, increases transmission latency, and frequently results in packet loss or network timeouts (e.g., broadcast storms). Consequently, existing telecommunication and network infrastructures cannot support the bandwidth required for real-time duplicate check verification across the entire financial sector.

Additionally, current solutions require that financial institutions use their own name matching techniques in an attempt to determine whether the payee name on the check matches a particular account holder. This results in numerous name matching algorithms that lead to inconsistent results from one financial institution to another. For example, a user having a middle initial omitted on the payee line of the check may have the check accepted at one bank and denied at another bank due to differing name matching algorithms.

Therefore, improvements in techniques for handling treasury checks to mitigate the risk of fraud associated with check washing and to improve the consistency of the check redemption process are desired.

### BRIEF SUMMARY OF THE INVENTION

A risk assessment system may include one or more processors and a memory having instructions stored thereon that, when executed by the one or more processors, cause the one or more processors to receive check information associated with a treasury check from a receiving institution. The check information may include a first payee name printed on the treasury check, a check number of the treasury check, an amount of the treasury check, and a routing number of the treasury check. The instructions may cause the one or more processors to send at least a portion of the check information to an issuing treasury institution. The instructions may cause the one or more processors to receive, from the issuing treasury institution, a second payee name. The second payee name may have been printed on the treasury check issued by the issuing treasury institution. The instructions may cause the one or more processors to determine whether the treasury check has already been redeemed at another financial institution. The instructions may cause the one or more processors to provide a response to the receiving institution. The response may include one or both of the second payee name and an indication of whether the first payee name and the second payee name match.

In some embodiments, the instructions may further cause the one or more processors to perform a name matching process on the first payee name to identify whether the first payee name matches one or more other identities. Determining whether the treasury check has already been redeemed at another financial institution may be based at least in part on a result of the name matching process. The instructions may further cause the one or more processors to provide an indication to the receiving institution whether the first payee name matches an account maintained at the receiving institution. Determining whether the treasury check has already been redeemed at another financial institution may include determining that the treasury check has been previously submitted at another institution. The instructions may further cause the one or more processors to send an alert to the receiving institution that indicates that the treasury check has been previously submitted at another institution. Determining that the treasury check has been previously submitted at another institution may be based at least in part on one or both of the check number of the treasury check and the routing number of the treasury check. The instructions may further cause the one or more processors to alert at least one other institution that the treasury check has been previously submitted.

Some embodiments of the present technology may encompass methods of assessing risk. The methods may include receiving, by a risk assessment system, check information associated with a treasury check from a receiving institution. The check information may include a first payee name printed on the treasury check, a check number of the treasury check, an amount of the treasury check, and a routing number of the treasury check. The methods may include sending, by the risk assessment system, at least a portion of the check information to an issuing treasury institution. The methods may include receiving, by the risk assessment system and from the issuing treasury institution, a second payee name. The second payee name may have been printed on the treasury check issued by the issuing treasury institution. The methods may include determining whether the treasury check has already been redeemed at another financial institution. The methods may include providing, by the risk assessment system, a response to the receiving institution. The response may include one or both of the second payee name and an indication of whether the first payee name and the second payee name match.

In some embodiments, the receiving institution may include a first receiving institution. The methods may include determining that the treasury check is fraudulent based on the first payee name and the second payee name being different. The methods may include receiving a check inquiry from a second receiving institution. The methods may include providing a risk score to the second receiving institution. The risk score may be based at least in part on determining that the treasury check is fraudulent. The response may include the indication of whether the first payee name and the second payee name match. The methods may include generating a risk score that is indicative of a level of risk associated with a given treasury check having the first payee name on a payee line of the given treasury check. The methods may include sending the risk score to the receiving institution. The methods may include identifying a check history associated with the first payee name from one or more bank accounts. The risk score may be generated at least in part based on the check history. The risk score may be provided to the receiving institution with the response. The risk score may be based, at least in part, on whether prior checks having the first payee name on a payee line of each prior check have been deemed to be fraudulent.

Some embodiments of the present technology may encompass non-transitory computer-readable media having instructions stored thereon that, when executed by one or more processors, cause the one or more processors to receive check information associated with a treasury check from a receiving institution. The check information may include a first payee name printed on the treasury check, a check number of the treasury check, an amount of the treasury check, and a routing number of the treasury check. The instructions may cause the instructions to send at least a portion of the treasury check information to an issuing treasury institution. The instructions may cause the instructions to receive, from the issuing treasury institution, a second payee name. The second payee name may have been printed on the treasury check issued by the issuing treasury institution. The instructions may cause the instructions to determine whether the treasury check has already been redeemed at another financial institution. The instructions may cause the instructions to provide a response to the receiving institution. The response may include one or both of the second payee name and an indication of whether the first payee name and the second payee name match.

In some embodiments, the instructions may further cause the one or more processors to send a risk score to the receiving institution. The risk score may be indicative of a level of risk associated with a given treasury check having the first payee name on a payee line of the given treasury check. The risk score may be based, at least in part, on whether the first payee name is associated with a prior fraudulent treasury check. The risk score may be further indicative that the first payee name has been associated with passing a bad check. The issuing treasury institution may be the U.S. Treasury or a state treasury. The instructions may further cause the one or more processors to perform a name matching process on the first payee name. The instructions may further cause the one or more processors to identify one or more accounts associated with the first payee name based on a result of the name matching process. The instructions may further cause the one or more processors to generate a risk score that is indicative of a level of risk associated with a given treasury check having the first payee name on a payee line of the given treasury check based at least in part on the one or more accounts. The instructions may further cause the one or more processors to send the risk score to the receiving institution.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a system for performing a check acceptance process in accordance with the present invention.

FIG. 2 is a swimlane diagram of a process for performing a check acceptance process in accordance with the present invention.

FIG. 3 is a flowchart depicting an entity resolution process according to embodiments of the present invention.

FIG. 4 is a block diagram of a computer system in accordance with the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to systems and methods for reducing the risk to financial institutions at which negotiable instruments, such as treasury checks, are redeemed for cash or deposit. In particular, embodiments of the present invention provide solutions that involve a risk assessment system that is networked with a consortium of financial institutions and that operates as an intermediary between different financial institutions. For example, the risk assessment system may receive check information associated with the redemption of a check or other negotiable instrument from a receiving financial institution (i.e., the financial institution at which the negotiable instrument has been presented for redemption). The risk assessment system then communicates some of the check information to the issuing institution (i.e., institution that issued the negotiable instrument, which may be a treasury department in some embodiments). In response, the issuing institution sends original check information as issued by the issuing institution. The risk assessment system then supplies the receiving financial institution with an indication of whether the payee name shown on the redeemed negotiable instrument matches an original payee name printed on the check by the issuing institution. In some instances, the indication may include the original payee name, an indication of whether the payee names match, or both. Based on this information, the receiving financial institution may better determine whether the redeemed negotiable instrument is authentic or fraudulent in nature when determining whether to fund the individual who is redeeming the negotiable instrument.

In some embodiments, to further improve the receiving institution's ability to assess the risk associated with a particular negotiable instrument, a risk score may be provided to the receiving financial institution. The risk score may be indicative of a level of risk associated with the negotiable instrument and/or with a payee listed on the negotiable instrument. By enabling the comparison of the original payee name and the payee name on the presented negotiable instrument, embodiments of the present invention may help significantly reduce Treasury Check payee name fraud, which may help reduce certain fraud-attributed losses by up to $300 million per year. Such solutions are not practically possible via human-only and/or conventional computerized systems, as the pre-established access to the treasury records and real-time or near real-time ability of the present invention is essential to the ability of depositing banks to determine whether the treasury check is authentic prior to accepting the check for deposit or cash redemption.

The risk assessment system may apply an entity resolution process (or other name verification process) to the payee name to identify any additional names and/or accounts of an entity that may be associated with the payee listed on the negotiable instrument. This name matching may be used to ensure that a payee may successfully redeem the negotiable instrument even if there is a slight variation between the payee name and the account holder name. For example, an account holder may open an account with financial institution using his or her first, middle, and last name. An issuing financial institution may issue a check with the account holder's middle name omitted. The entity resolution process may help verify that the payee name does, in fact, match the account holder name and may enable the account holder to successfully redeem the negotiable instrument despite the slight mismatch in the names. By having the risk assessment system perform the entity resolution process (rather than having each financial institution perform their own name matching process), embodiments may help ensure that all name/identity matching is performed in uniform manner across the consortium of financial institutions to ensure that check redemption is a consistent process at all of the member financial institutions.

The entity resolution process may also enable the risk assessment system to better identify instances of duplicate redemptions of the negotiable instrument, such as those in which a bad actor attempts to redeem the negotiable instrument at different financial institutions with which the bad actor has accounts under slightly different names, such as nicknames that are similar to the listed payee name (e.g., Robert, Bob, Bobby, Rob, etc.), use or omission of one or more middle names, name variations, name misspellings, etc. The entity resolution process performed by the risk assessment system may ensure that the identification of related entities is conducted in a uniform manner for all negotiable instruments presented for redemption at financial institutions that are members of the consortium. This helps eliminate inconsistencies in the identification of related entities that otherwise occur when each financial instrument develops and conducts such processes independently.

As noted above, records of fraudulent negotiable instruments may be maintained and used to assess whether a given check has been previously redeemed and/or whether a redeeming payee has been associated with fraudulent checks. For example, the risk assessment system may access records of all negotiable instruments that have been redeemed at the member financial institutions to determine whether a particular redemption attempt involves a previously redeemed check. This information may be used to help generate the risk scores and/or otherwise alert one or more financial institutions of potential risks during future redemption attempts involving a given check and/or payee. As the duplicate redemption verification happens at a single entity (the risk assessment network), this verification may be performed in real-time or near real-time, which may help ensure that the receiving financial institution gets an indication of whether the redemption involves a duplicate check prior to accepting the check. This may enable the receiving financial institution to make a decision to deny the redemption of the check and thereby prevent any duplicate check fraud from occurring. Such abilities are not possible with conventional systems that rely on the receiving bank to determine whether a given redemption involves a duplicate check. While discussed primarily in terms of treasury checks, it will be appreciated that the systems and methods described herein may be equally applicable to other forms of negotiable instruments.

Such solutions not only help reduce and prevent treasury check fraud but also help improve the flow of data between the various entities, which helps reduce network traffic. Notably, by serving as an intermediary between the various financial institutions, the risk assessment system may reduce the number of communications needed to verify that a given negotiable instrument has not been previously redeemed. For example, as negotiable instruments are redeemed at financial institutions within the consortium, each financial institution may send a record of the redemption to the risk assessment network which may store the record. When the risk assessment system receives the check information from the receiving bank, the risk assessment system may then check its own databases to determine whether the check information matches any previously redeemed checks. Thus, only a single inquiry is required to determine whether the current redemption attempt involves a duplicate check. In contrast, existing solutions require a receiving financial institution to send individual communications to every other financial institution to verify whether the current redemption attempt involves a duplicate check. Due to the existence of vast numbers of different financial institutions, duplication verification efforts without the use of the risk assessment network would require thousands of inquiries to be sent for each redemption attempt, which would introduce an enormous volume of network traffic that would be practically unfeasible to implement on existing network infrastructure. Thus, the present solutions change how information flows between the various financial institutions and helps reduce network traffic, thereby improving the performance of the financial institution computing systems, servers, and other network infrastructure.

By utilizing the risk assessment system 104 as a centralized routing intermediary, the system 100 provides a concrete improvement to the functioning of the computer network itself. Specifically, the system 100 converts a decentralized, high-bandwidth mesh routing protocol into a highly efficient hub-and-spoke network topology. When a check is presented, the receiving financial institution 102b transmits a single, localized inquiry over the network 106 to the risk assessment system 104. The risk assessment system 104 then queries its centralized databases 108, reducing the required network transmissions from thousands of disparate server requests to a single O(1) routing operation from the perspective of the receiving financial institution 102b. This specific network architecture fundamentally reduces the volume of network traffic, conserves network bandwidth, minimizes packet collision, and reduces the processing load on the remote financial institution servers, thereby enabling real-time duplicate check verification that was previously impossible on existing network infrastructures.

Additionally, due to the large number of financial institutions, programming a computing system of one financial institution to communicate with all or significant numbers of the other financial institutions would require significant effort to incorporate different APIs, message formats, and the like. The present solutions simplify the programming requirements by requiring each financial institution to integrate only with the risk assessment system, rather than with each financial institution individually, while still enabling duplicate check determinations and other inquiries to be performed across the entire consortium of financial institutions.

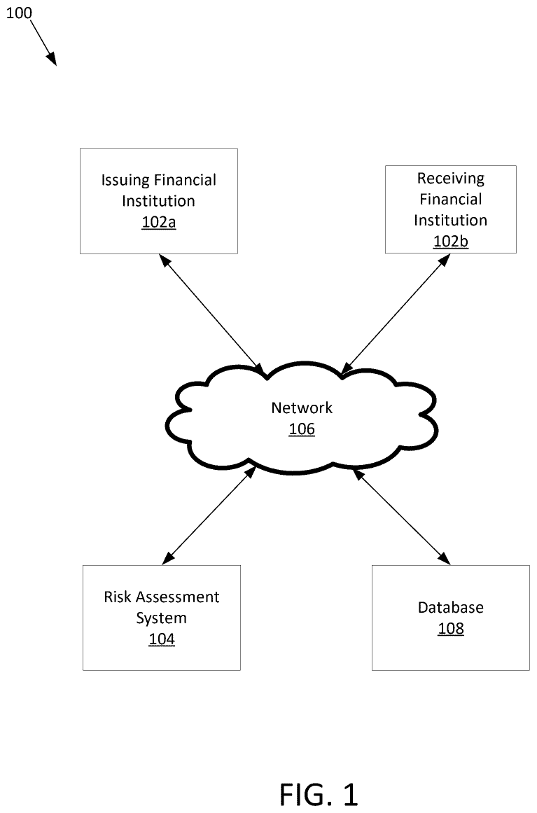

Turning now to FIG. 1, a system 100 for performing risk assessment for negotiable instruments is illustrated. The system 100 may include a number of financial institutions 102, which may include banks, credit unions, treasury departments, and other entities that issue and/or accept deposits of negotiable instruments for payments such as checks. At least some of the financial institutions 102 may maintain a number of accounts that may send and/or receive funds using checks. As shown here, the financial institutions 102 may include issuing financial institutions 102a (e.g., financial institutions that issue negotiable instruments, such as checks, treasury checks, and the like) and receiving financial institutions 102b (e.g., financial institutions 102 at which a given negotiable instrument is presented for cash and/or deposit). Oftentimes, a single financial institution 102 may operate as an issuing financial institution 102a and a receiving financial institution 102b in a single transaction and/or across distinct transactions. In other embodiments, the issuing financial institution 102a and receiving financial institution 102b may be different or separate financial institutions that operate independently from one another. The receiving financial institution 102b may make a determination of whether to accept or deny the redemption of a given negotiable instrument. This determination may involve assessing the risk of the negotiable instrument being fraudulent as will be discussed in greater detail below.

In a particular embodiment, the issuing financial institution 102a may be a treasury, such as the U.S. Treasury or a state treasury. In such embodiments, the negotiable instrument may be a treasury check that is issued by the respective treasury institution. The treasury institution may maintain records of each issued treasury check, including an account number, routing number, amount, payee name, address, and/or other information associated with a given treasury check. For example, in many instances described herein, the issuing financial institution 102a may be a treasury, while the receiving financial institution 102b may be a private bank or credit union, or other such financial institution.

The system 100 may include a risk assessment system 104, which may be in communication with each of the financial institutions 102, such as via one or more networks 106. In operation, the risk assessment system 104 may receive check information from a receiving financial institution 102b. For example, a payee may present the check for redemption, such as for deposit and/or in exchange for cash, at the receiving financial institution 102b. The receiving financial institution 102b may extract and/or otherwise identify check information from the redeemed check and provide the check information to the risk assessment system 104. The check information may include, without limitation, a payee name printed on the check, a payee address printed on the check, a check number of the check, an amount of the check, a routing number of the check, and/or other information associated with the check. The risk assessment system 104 may communicate all or a portion of the check information, such as the routing number and check number, to the issuing financial institution 102a. The issuing institution 102a may use the received check information to identify the originally issued check and to retrieve the record of the issued check. At least some information from the record of the issued check may be returned to the risk assessment system 104. For example, the original payee name (and possibly other information such as the original amount) from the issued check may be provided to the risk assessment system 104. The risk assessment system 104 may provide a response to the receiving financial institution 102b, with the response enabling the receiving financial institution 102b to determine whether the payee name on the redeemed check matches the original payee name from the record of the issued check maintained by the issuing financial institution 102a. For example, the response may include the original payee name and/or an indication of whether the payee name on the redeemed check and the original payee name match. If the payee names match, the receiving financial institution 102b may decide to accept the check or to evaluate the risk of the check using other risk factors (such as a risk score, etc.). If the payee names do not match, the receiving financial institution 102b may determine that the check is likely fraudulent and may deny the check. In such instances, the receiving financial institution 102b may also report the payee on the check to one or more authorities for investigation into the potential fraudulent check. The receiving financial institution 102b may report the payee as being associated with a fraudulent check to the risk assessment system 104, which may use such information the generation of a risk score and/or to otherwise alert other financial institutions 102 of risk associated with the particular payee. In some embodiments, the risk assessment system 104 may request the payee name on the negotiable instrument presented to the receiving financial institution 102b and match that name to the name associated with the record of the issued negotiable instrument from the issuing financial institution 102a. The risk assessment system 104 may then return the result of that match and/or the risk score of that match to the receiving financial institution 102b. The receiving financial institution 102b can then determine whether or not to pay the negotiable financial instrument based at least in part on the match result and/or risk score of that match.

The response may be sent within a short time from when the risk assessment system 104 received the check information from the receiving financial institution 102b. For example, the response may be provided to the receiving financial institution 102b within 1 minute of receipt of the check information, within 45 seconds of receipt of the check information, within 30 seconds of receipt of the check information, within 15 seconds of receipt of the check information, within 10 seconds of receipt of the check information, within 5 seconds of receipt of the check information, within 3 seconds of receipt of the check information, within 1 second of receipt of the check information, or less. Such timing may provide a near real-time solution that provides the receiving financial institution 102b with the ability to determine whether the check is likely fraudulent due to a payee name mismatch prior to accepting the check, which may help reduce the risk that the receiving financial institution 102b has the liability for the funds of the check if ultimately deemed fraudulent.

The risk assessment system 104 may include or be in communication with one or more databases 108. The databases 108 may include historical account and transaction data associated with the payee (e.g., an account owner) and/or the check number. For example, the databases 108 may include records (e.g., balances, transactions, account ages, average deposit amounts, etc.) of each account managed by the financial institutions 102, along with information about the owner(s) of each account, such as personally identifiable information about each owner. The databases 108 may include information about the check history (e.g., check velocity, amounts, payors, etc.) of each account and/or account owner. To facilitate the population of the databases 108, the risk assessment system 104 may establish relationships with any number of the financial institutions 102. The account and owner data associated with the accounts may be provided to the databases 108 from the financial institutions 102 themselves, in real-time and/or in batch mode. This may enable the risk assessment system 104 to access up to date historical and transaction data for each account and/or account owner and may enable the risk assessment system 104 to determine risk factors and/or risk scores for accounts and/or owners thereof across a large number of financial institutions 102. The risk assessment system 104 may retrieve and/or analyze data associated with a given payee and provide a risk score to the receiving financial institution 102b associated with a given negotiable instrument, as will be discussed in greater detail below. The financial institutions 102 may use these risk scores in determining whether to accept or deny a given check or other negotiable instrument.

In some embodiments, the databases 108 may also be used by the risk assessment system 104 to look up whether a given check has already been redeemed, enabling the risk assessment system 104 to alert the receiving financial institution 102b that the check is a duplicate prior to being accepted. For example, the risk assessment system 104 may match the routing number, check number, payee name, date, amount, and/or other check information of the check against information within the databases 108 to determine whether the check has been redeemed or otherwise presented (e.g., presented and denied) for redemption at one or more other financial institutions 102. In some instances, the routing number and check number of may be used to identify exact duplicate check matches. In other instances, other information may be used in addition to, or in place of, the routing number and/or the check number. For example, the risk assessment system 104 may determine whether a single check number has been presented at a number of financial institutions 102 with a same payment amount. If a match is found, the risk assessment system 104 may communicate an alert to the receiving financial institution 102b with an indication that the check has been previously redeemed or otherwise presented at another financial institution 102. The alert may be sent along with the response and/or as a separate message and may be communicated in real-time or near real-time. This may enable the receiving financial institution 102b to make a more informed decision about whether to accept or deny the check.

The system architecture of system 100 in which the risk assessment system 104 serves as an intermediary between the financial institutions 102 of the consortium and conduct the duplicate check verification process enables duplicate check fraud to be prevented while also reducing the demands on network traffic relative to what existing systems would need to implement such duplicate check verification processes. For example, the risk assessment system's 104 operation as an intermediary enables the receiving financial institution 102b to make a single inquiry to the risk assessment system 104 regarding whether the check is a duplicate, rather than requiring the receiving financial institution 102b to send individual inquiries to all the other financial institutions 102 (which would not be feasible using current network infrastructure as each check redeemed would require thousands of individual inquiries and responses to be communicated over various networks). This drastically cuts down on network traffic and enables the duplicate check verification process to be practically implemented.

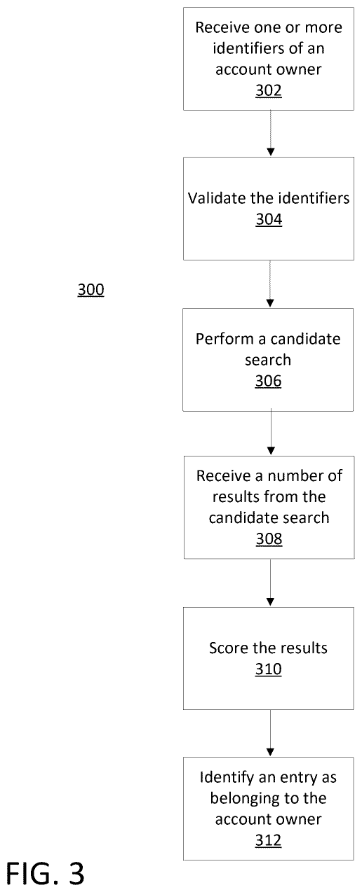

In some embodiments, the risk assessment system 104 may perform a name matching process on the payee name provided by the receiving financial institution 102b. The name matching process may be used to determine an identity associated with the payee name and may enable the payee name to be associated with an account holder name even when slight variations exist between the payee name and the account holder name. For example, the account holder may open one or more accounts with one or more variations of his or her name, while the check may use a different variation. As just a few examples, the variations may include a person's legal name, a nickname, informal and/or alternatives versions/spellings (e.g., Bob, Bobby, Robert, Rob, etc.) use of a middle name and/or middle initial, a slightly misspelled name, etc. Variations between the account holder name and the payee name may exist due to inconsistent usage of a person's own name in opening accounts and/or filling out forms, due to mistakes (e.g., clerical errors), and/or due to limitations with a given form. For example, when filling out an account enrollment form, a tax return, and/or other form that may be associated with an account and/or payment, a person may encounter limitations due to the data requirements of the form (e.g., the number of characters may be limited, there may be no room for one or more middle names, etc.), which may force the person to input a different form of his or her name in the form. The name matching process may help identify possible alternate names and may help eliminate problems associated with the existence of variations of a given person's name. In some embodiments, the name matching process may involve identifying possible variations of a given name and evaluating a degree of mismatch between the listed payee name and the possible variations to determine a likelihood that the payee name and the variations belong to a particular individual. In some embodiments, the name matching process may involve an entity resolution process such as described in relation to FIG. 3.

The name matching process may be used to help ensure that the redeemer of the check is able to successfully redeem the check (i.e., the check is accepted for redemption by the receiving financial institution 102b) when the name matching process indicates that there is a high likelihood of a match in the event that the payee name slightly differs from the account holder name registered at the receiving financial institution 102b and where no other issues present themselves (e.g., detection of payee name mismatch with the originally printed check, detection of duplicate checks, other known fraud risk factors, etc.). By performing the name matching process at the risk assessment system 104 (rather than at each individual financial institution 102, which would result in numerous name matching algorithms), the system 100 may ensure that the name matching is performed in a consistent manner for all checks presented for redemption at member financial institutions of the consortium. This results in predictable and repeatable check acceptance and denial decisions and helps ensure that good actors are more likely to be able to redeem the checks even in situations in which slight variations between the payee name and account holder name exist.

The name matching process may also enable the risk assessment system 104 to better identify instances of duplicate redemptions of the negotiable instrument by identifying instances where a check serial number has been redeemed multiple times by users with slightly different names. Additionally, the name matching process may enable the risk assessment system 104 to identify a number of financial accounts at one or more other financial institutions 102 (other than the receiving financial institution 102b). For example, after detecting possible name variations, the risk assessment system 104 may match the name (and variations thereof) and/or other PII of the printed payee name and/or account holder attempting to redeem the check to associated with names and/or other PII on the databases 108 to identify one or more other accounts associated with the payee name and/or the account holder name. When a match is found, the risk assessment system 104 may access account data and/or transaction data associated with each identified account. The account data and/or transaction data may be used to perform fraud risk scoring and/or other fraud detection and mitigation services in some embodiments. The risk scores may be provided to the receiving financial institution 102b that is associated with a given check. The receiving financial institution 102b may use the risk scores to further assess the risk of fraud associated with the check. In some embodiments, the risk scores may be generated by a human-developed risk model. For example, the risk model may analyze a number of risk factors to generate a risk score associated with checks to or from a given account and/or account owner. In some embodiments, the risk model may assign equal weights to each risk factor, while in other embodiments the risk model may assign one or more of the risk factors with different weights. In some embodiments, the risk factors and/or associated weights may be selected by the risk assessment system 104, while in some embodiments each financial institution 102 may select the risk factors and/or associated weights that they deem important in assessing risk to be utilized in generating the risk score. In some embodiments, the risk factors may include whether prior checks having the payee name on a payee line of the prior check have been deemed to be fraudulent and/or whether the payee name has been associated with a prior fraudulent treasury check. This may enable the risk assessment system 104 to generate risk scores that factor in whether a payee has committed fraud at a different receiving financial institution 102b and/or at a different account. Additionally, or alternatively, the risk factors may include check velocities associated with the payee's various accounts. By utilizing the check velocity and/or other account history of the payee (or other person or entity depositing the checks) across the various financial institutions 102, the risk assessment system 104 can better predict the risk of a future risk of checks from this same payee or entity getting returned because of fraudulent reasons.

In some embodiments, the risk scores may be generated using a machine learning model. For example, the risk assessment system 104 may include a machine learning risk model (such as a Gradient Boosted Trees model) that has been trained to predict the probability that a given check is fraudulent. For example, the risk model may be provided with data from a number of prior fraudulent checks and/or a number of prior valid checks. The risk model may be trained to identify various fraud risk factors (including account, transaction, and/or negotiable instrument characteristics) that may be indicative of fraudulent checks.

For example, a number of checks that are known to be fraudulent and/or checks that are known to be authentic may be provided to the machine learning model as input variables. Each check may include an indication of whether the particular check was fraudulent, along with other transaction and/or other information about the check, a payee name, an account associated with the check (e.g., a destination account), and/or an owner of the account associated with the check. For example, each check may include one or more pieces of information, such as a payment amount, a time and/or date on the check, a date of presentation/deposit of the check, a location of the presentation of the check, a payee name, an address, and/or other data. Additionally, some or all of the checks may include additional information related to the recipient and/or sender (e.g., account owners), such as one or more of the fraud risk factors outlined above. The check information (and possibly the additional information) may be analyzed by the machine learning model in view of the indication of whether each check was authentic or fraudulent, enabling the machine learning model to generate a number of sets of check, payee, and/or account characteristics that are indicative of a high risk of fraud. When a new check is analyzed, the relevant check information may be supplied to the machine learning model, which may identify characteristics associated with the new check to determine whether the new check is likely fraudulent. The use of such a machine learning model to generate the risk scores enables vast amounts of prior check, account, and account owner data to be analyzed to identify various risk factors that are indicative of risk that a given check is fraudulent. The machine learning risk model may be able to analyze a vast quantity of data and identify complex patterns within the data to identify risk factors that are not likely or possible to be identified using human-generated models and may provide greater accuracy in identifying fraudulent checks.

In some embodiments, the risk model may behave deterministically (e.g., an inquiry with the same information scored by the model with the same feature values will always produce the same score). In other embodiments the risk model can be updated/retrained multiple times (e.g., the model can change upon retraining of the model, when the model goes through model governance, and/or when a new version of the model is deployed). For example, the model may be updated/retrained after new checks have been presented for deposit and/or cash redemption at one or more financial institutions. In some embodiments, the risk assessment system 104 may monitor current check scams and other fraudulent activity. For example, the risk assessment system 104 may receive information on fraudulent checks and scams from the various user financial institutions 102 and/or other external sources. The risk assessment system 104 and/or risk model may analyze this information to identify characteristics that are indicative of such fraud. For example, the risk assessment system 104 and/or risk model may be supplied with information from known fraudulent check transactions to identify combinations of different fraud risk factors (such as those described above) that may be indicative of a fraudulent check based on the information on fraudulent checks and scams provided by the various user financial institutions 102 and/or other external sources. The risk assessment system 104 may also maintain and update information and educational resources on the various fraudulent activities that may be used to instruct the financial institutions 102 on how to handle various fraudulent activity. For example, information on what the financial institutions 102 should look for to detect fraudulent checks and/or steps that may be taken to avoid and/or reduce the threat of falling victim to fraud. The risk assessment system 104 may monitor trends in various scams, which may be used to keep information up to date and to best educate the various partner financial institutions 102 of the risk assessment system 104.

In some embodiments, the risk scores may factor in various information, such as whether a treasury check (or other check) has been returned by a financial institution 102, which may indicate possible fraud. For example, if a treasury check with no identified risk indicators is returned by a financial institution 102, a reason for this return may then be a treasury check payee name mismatch. In this case, if the same payee name submits another check within the financial institutions 102 that have established relationships with the risk assessment system 104, there may be an increased probability that the same person is trying to fraudulently submit another check. This information may be used to adjust the risk score to indicate a higher risk of fraud associated with the payee. The risk assessment system 104 may inform other financial institutions 102 if the same payee name submits another check with a different financial institution 102. If a treasury check by a person or entity has been returned in the past, there is an increased chance that the owner of the check has tried to commit fraudulent activity and may do so again when submitting a check elsewhere. If a treasury check by a person or entity has been return in the past, there is an increased probability that the owner of this check has tried to commit a fraudulent activity and may do so again when they submit a check elsewhere. Such behaviors may lead to adjustments in risk scores to flag or otherwise identify the person or entity to better alert other financial institutions 102 of the risk associated with this payee.

The risk scores may be continually updated, in real-time upon the risk assessment system 104 and/or databases 108 receiving new information from one or more of the financial institutions 102 and/or periodically at predetermined intervals (e.g., daily, weekly, monthly, etc.). In some embodiments, the risk scores may be updated after each transaction with one of the financial institutions 102. The risk scores may take various forms. For example, the risk scores may be provided as a numerical and/or alphanumerical score having a range of values that indicate whether the fraud risk is low or high. In some embodiments, the risk score may be and/or may include a status code. The status code may provide an indication of what risk factor(s) led to a particular level of fraud risk. For example, a risk code may indicate that a prior redemption attempt for the check attempt has been detected at another financial institution 102 within the consortium (e.g., the check is likely a duplicate), whether the payee name and/or account holder redeeming the check has previously committed fraud within the consortium, and/or other activity. Thus, the status code may provide additional context that the receiving financial institution 102b may use to make an informed decision regarding whether to accept or deny the check.

As noted above, the financial institutions 102 and the risk assessment system 104, and/or databases 108 may be connected via one or more wired and/or wireless networks 106. Data transmitted across the networks 106 may be secured using encryption techniques, hypertext transfer protocol secure (HTTPS), secure sockets layer (SSL), transport layer security (TLS), and/or other security protocol.

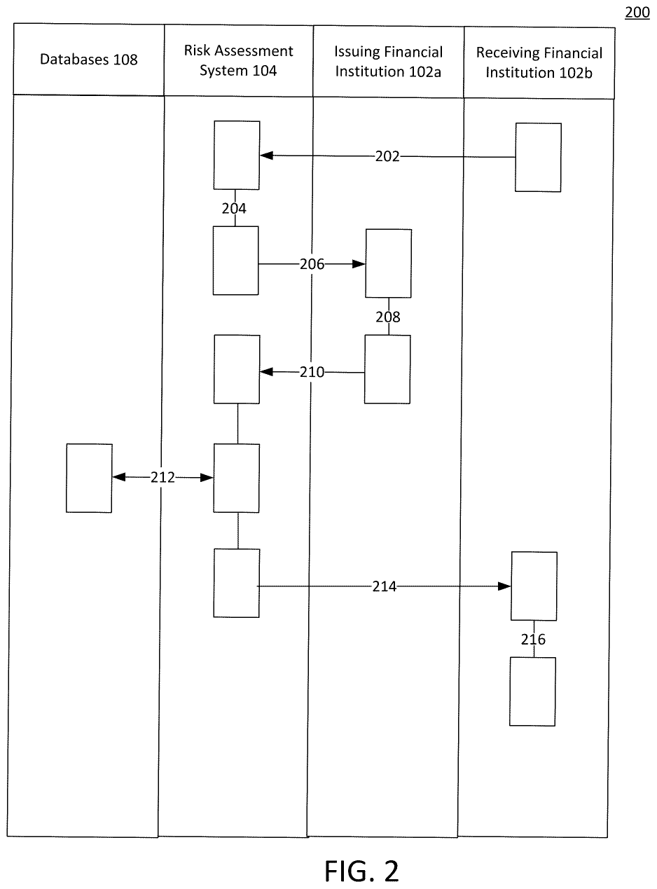

FIG. 2 illustrates a swimlane diagram showing interactions between different entities of system 100 as part of a check acceptance procedure or process 200. The check acceptance process 200 may be initiated by a payee presenting a check, such as a treasury check, to a receiving financial institution 102b in exchange for cash and/or for deposit in a destination account managed by the receiving financial institution 102b. At operation 202, the receiving financial institution 102b (e.g., a financial institution 102 at which the check is presented) may provide check information associated with the check to the risk assessment system 104. The check information may include, without limitation, a payee name printed on the check, an address, a check number of the check, an amount of the check, an account number of the check, and/or a routing number of the check. The check information may be provided by sending an image of the check to the risk assessment system 104 and/or by the receiving financial institution 102b extracting and/or otherwise identifying the check information and sending the extracted check information to the risk assessment system 104. Where an image of the check is provided, the risk assessment system 104 may parse the check information from the image, such as by using optical character recognition processes on the image to identify individual data fields of the check.

The risk assessment system 104 may analyze the check information and identify an issuing financial institution 102a associated with the check at operation 204. For example, the risk assessment system 104 may use the routing number of the check to identify the financial institution 102 that issued the check. Once the issuing financial institution 102a has been identified, the risk assessment system 104 may send at least a portion of the check information to the issuing financial institution 102a at operation 206. For example, the risk assessment system 104 may send enough of the check information for the issuing financial institution 102a to identify the check that is being presented to the receiving financial institution 102b. In some embodiments, this may include sending all of the check information, while in other embodiments only a subset of the check information may be sent to the issuing financial institution 102a. At a minimum, the risk assessment system 104 may send the check number of the presented check to the issuing financial institution 102a. Where the issuing financial institution 102a maintains multiple issuing accounts, the account number of the check may also need to be included in the transmission to the issuing financial institution 102a.

The issuing financial institution 102a may use the check information, and in particular the check number and/or account number, to identify the presented check at operation 208. The issuing financial institution 102a may then determine the original check information that was printed and/or otherwise provided on the check when originally issued by the issuing financial institution 102a. The original check information may include the original payee name and, optionally, additional information such as (but not limited to) an issue date of the check, an amount of the check, and/or other information. At least some of the original check information (including the original payee name) may be sent to the risk assessment system 104 at operation 210.

In some embodiments, the risk assessment system 104 may determine whether the treasury check has already been redeemed at another financial institution 102 at operation 212. For example, the risk assessment system 104 may attempt to match at least a portion of the original check information and/or the check information received from the receiving financial institution 102b to information within one or more databases 108 of prior account data and/or transaction data. The databases 108 may include account data and/or transaction data from all or a portion of the accounts maintained at the member financial institutions 102 of the consortium and may enable the risk assessment system 104 to identify whether a presented check has been previously redeemed at one or more other financial institutions 102. For example, the routing number, account number, check number, and/or other check information may be compared to those of prior known check redemptions and/or attempts at member financial institutions 102 of the consortium. The risk assessment system 104 may then provide the receiving financial institution 102b with an indication of whether the check has been previously presented at another financial institution. For example, if a matching check is located, the risk assessment system 104 may determine that the check is a duplicate and may inform the receiving financial institution 102b of the duplicate status. If no matching check is located, the risk assessment system 104 may determine that the check is not a duplicate and inform the receiving financial institution 102b that no duplicate issues are present (or provide no indication of non-duplicate status). Based on the information from the risk assessment system 104, the receiving financial institution 102b may determine whether to accept or deny the check.

Based on the original check information, the risk assessment system 104 may provide a response to the receiving financial institution 102b at operation 214. The response may include the original payee name and/or an indication of whether the payee name on the presented check and the original payee name match. In some embodiments, the response may include the result of the duplicate check verification. The receiving financial institution 102b may use the information from the response as part of a determination of whether to accept or deny the check at operation 216. For example, where the payee name on the presented check does not match the original payee name (either based on the indication or based on the receiving financial institution 102b comparing the received original payee name with the payee name on the presented check), the receiving financial institution 102b may determine that the check is fraudulent and deny the check. Where the payee name on the presented check does match the original payee name, the financial institution 102b may accept the check and/or perform further fraud detection steps (such as analyzing a risk score, reviewing other check data, etc.) prior to making a determination to accept or deny the check. For example, in some embodiments, the receiving financial institution 102b may compare other data from the original check information to corresponding data on the presented check. As just one example, the receiving financial institution 102b may compare the original payment amount with the payment amount shown on the presented check to ensure the payment amount has not been altered prior to accepting or denying the check.

In some embodiments, the risk assessment system 104 may perform a name matching process on the original payee name and/or the payee name provided by the receiving financial institution 102b. The name matching process may be used to determine an identity associated with the payee name and may enable the payee name to be associated with an account holder name even when slight variations exist between the payee name and the account holder name. In some embodiments, the name matching process may involve an entity resolution process such as described in relation to FIG. 3. The name matching process may be used to help ensure that the redeemer of the check is able to successfully redeem the check (i.e., the check is accepted for redemption by the receiving financial institution 102b) when the name matching process indicates that there is a high likelihood of a match in the event that the payee name slightly differs from the account holder name registered at the receiving financial institution 102b and where no other issues present themselves (e.g., detection of payee name mismatch with the originally printed check, detection of duplicate checks, other known fraud risk factors, etc.). The name matching process may also enable the risk assessment system 104 to better identify instances of duplicate redemptions of the negotiable instrument by identifying instances where a check serial number has been redeemed multiple times by users with slightly different names.

Additionally, the name matching process may enable the risk assessment system 104 to identify a number of financial accounts at one or more other financial institutions 102 (other than the receiving financial institution 102b). For example, after detecting possible name variations, the risk assessment system 104 may match the name (and variations thereof) and/or other PII of the printed payee name and/or account holder attempting to redeem the check to associated with names and/or other PII on the databases 108 to identify one or more other accounts associated with the payee name and/or the account holder name. When a match is found, the risk assessment system 104 may access account data and/or transaction data associated with each identified account. The account data and/or transaction data may be used to generate and send a risk score to the receiving financial institution 102b. The risk score may be sent with the response in some embodiments. For example, the check information of the check may be provided to a risk model of the risk assessment system 104. In some embodiments, the risk model may be a human-generated risk model in which a number of inputs (e.g., risk factors) associated with the check and/or the payee may be analyzed and/or weighted to produce a risk score. In other embodiments, the risk model may include a machine learning risk model that has been trained to generate risk scores based on the inputs. For example, historical and/or transactional information associated with the payee (and accounts associated with the payee) on the check may be retrieved from the databases 108 and provided to the machine learning risk model. The machine learning risk model may analyze the data and generate a risk score that is indicative of a probability that the check is fraudulent. More specifically, in some embodiments the risk score may be indicative of indicative of a level of risk associated with a given check having the payee name on a payee line of the given check and/or indicative that the payee name has been associated with passing a bad check. The risk score may be supplied to the receiving financial institution 102b.

In a particular embodiment, the risk score may be generated based on a check history associated with one or more accounts of the payee. For example, the risk assessment system 104 may utilize the payee name from the check to identify one or more bank accounts associated with the payee. The bank accounts may be at the receiving financial institution 102b and/or at one or more other financial institutions 102. Once some or all of the payee's accounts have been identified, the risk assessment system 104 may access account data of each account within the databases 108 and analyze the account data to determine various risk factors, such as the check velocity of the payee at one or more of the accounts. This check velocity information may be provided to the risk model and may factor into the risk score.

In some embodiments, upon determining that the check is fraudulent, the receiving financial institution 102b may provide an indication of the determination to the risk assessment system 104. If the risk assessment system 104 receives a subsequent inquiry (e.g., set of check information) from a second receiving financial institution 102b having a same payee name, the risk assessment system 104 may provide the second receiving financial institution 102b with a risk score that is based on at least in part on the indication of the determination that the payee's prior check was fraudulent. In other words, the risk score provided to the second receiving financial institution 102b may be increased or elevated as a result of the previous fraudulent check.

FIG. 3 is a flowchart illustrating one embodiment of an entity resolution process 300 in accordance with the present invention. Process 300 may be performed by the risk assessment system 104 and/or an entity and/or device/network that works in conjunction with the risk assessment system 104. For example, process 300 may be performed as part of a check acceptance process, such as process 200 described above, and may be used to match payee names with account holders who own one or more accounts at financial institutions 102 within the consortium. Process 300 may begin at operation 302 by the risk assessment system 104 receiving a payee name (e.g., from the issuing financial institution 102a and/or the receiving financial institution 102b) and/or other identifiers (such as PII). The payee name may be received as part of check information that is tied to check issued by and/or presented for redemption at a given financial institution 102. Other than the payee name, the PII may include, without limitation, a tax payer identifier (including a social security number), business registration and/or tax identifier, driver's license identifier, email address, employer identification number, military identifier, residency and/or citizenship identifier, passport number, registered charity number, residence alien identifier, a state-issued identifier, a student identifier, a voter identification number, a date of birth, an address, a phone number, and/or other identification means. At operation 304, the payee name and/or other PII may be validated, such as by scrubbing the identifiers for default and incorrect values of various fields. For example, only those identifiers that include a predetermined number of characters in length (e.g., 5 characters), that have a predetermined number of unique characters (e.g., 3 unique characters), and/or having at least one digit (or some other number of digits) may be used to look up the payee and/or account holder's financial accounts. In some embodiments, one or more additional (or alternative) validation steps may be performed. For example, taxpayer identification numbers (TINs) may be scanned for invalid values (e.g., 123456789, 987A654X321, 00101001, etc.). A TIN may be deemed invalid if all digits are the same, if the first three digits start with a certain sequence (e.g., 000 or 666) and/or satisfies a number of other conditions that may indicate that the TIN is not valid. For phone numbers, the risk assessment system 104 may remove any non-digit characters (e.g., hyphens, parentheses, periods, etc.), ensure that the phone number matches a pre-determined length (e.g., 10 digits), and/or whether the phone number includes any sequences of digits that are known to be invalid.

After the identifiers have been validated, a candidate search may be performed at operation 306. The candidate search may involve using one or more of the identifiers to search for financial accounts associated with matching identification data. Oftentimes, it may be advantageous to use unique identifiers (e.g., TIN, SSN, etc.) rather than the name of the particular person associated with the inquiry (which may not be unique to a given person) during the candidate search. The risk assessment system 104 may enter the selected identifier(s) into one or more account databases. Each database may be hosted by a financial institution 102, the risk assessment system 104, a third-party entity and/or other entity and may be populated with account data and/or transaction data regarding accounts maintained at one or more of the financial institutions 102 of the consortium. The account data and/or transaction data may include information regarding past checks that have been associated with a given account in some embodiments. In embodiments which a name is used as the identifier, the risk assessment system 104 may tokenize the name, split the name by spaces, omit any token under a predefined length (such as 2 characters), alias the name tokens, and/or otherwise process the name. For addresses, the risk assessment system 104 may tokenize the street and split into spaces and/or common address words and/or abbreviations (e.g., street, avenue, road, east, west, etc.) may be removed. In some embodiments a predetermined number of tokens must remain after processing steps for the address to be used in the candidate search.

A number of results from the candidate search may be returned at operation 308. The results may each be associated with an entry of an account owner. The results may include a listing of accounts, account data, and/or transaction data associated with the account holder. The results may also include other matches. For example, the results may include matches that include names that exhibit a predetermined level of similarity to one or more of the searched identifiers. After identification and analysis of results, all (or a predetermined top number) of the results may be scored at operation 310. The scoring may be performed using some or all types of identifiers associated with financial accounts identified in the candidate search. The scoring may include determining whether an account owner name associated with the new requested account matches the particular person. This may include standardizing the name components from account owner names associated with retrieved accounts. For example, the name may be broken down into tokens and non-letter characters may be removed. For each name component (e.g., prefix, given name, family name, suffix, etc.) a lookup may be performed to identify if there are one or more standard forms of the given name component. The lookup may return the original name components, any standardized components (linked by original component), abbreviated forms of any names(de-duplicated), encoded forms of names (de-duplicated), concatenated forms of the original name components (e.g., the name of the particular person as provided in the inquiry), a gender estimation based on the original components provided, and/or other information. For example, if the following name were entered for lookup: “Ms. Debbie Sue Smith Johnson,” the results may include the data in Table 1 below:

TABLE 1

| | Standard | Abbre- | | |
|---|---|---|---|---|
| Original | Form(s) | viated | Encoded | Concatenated |
| DEBBIE | DEBBIE, | D | TP | |
| | DEBORAH | | | |
| SUE | SUE, | S | S | DEBBIESUE |
| | SUSAN | | | |
| SMITH | SMITH | S | SM0, XMT | SUESMITH |
| JOHNSON | JOHNSON | J | JNSN, | SMITHJOHNSON |
| | | | ANSN | |

By converting the standardized name forms into abbreviated and encoded alphanumeric strings (as illustrated in Table 1), the system significantly reduces the memory footprint of the search query. Utilizing these encoded data structures reduces the search space within the massive historical transaction databases 108, directly decreasing the number of CPU cycles required to compare data arrays and resulting in significantly faster data retrieval times. Consequently, the scoring and entity resolution process is not merely a linguistic comparison, but a specific computational technique for reducing the processing overhead and latency of database querying operations when handling disparate and non-uniform data sets.

Converting the standardized name forms into abbreviated and encoded alphanumeric strings (as illustrated in Table 1) can also aid in the detection of high-quality counterfeit checks and fraudulent bank accounts. To perpetrate fraud, bad actors can utilize names that include multiple first, middle, and/or last names to cause confusion and make it more difficult to detect fraudulent activity. In some cases, bad actors will use variations of a name that includes multiple name tokens to open new accounts at different banks. Such name variations can be used on different checks with the same account number and routing number in attempt to cash the same check multiple times. For example, “Debborah Susan Smith” could be one name used to create different spelling variations such as, “Debora Suzan Smith,” “Debra Sussan Smithe,” and “Debrah Sussan Smythe.” Although these names include one or more characters misspelled, they are phonetically similar and difficult to detect. In another example, “Debborah Susan Johnson Smith” could be a base name or identity used to open several different accounts. This name and identity could be used to open a first account. A second account could be opened using the name and identity, “Deb Susan Smith,” a third account could be opened using the name and identity, “Debbie Sue Johnson Smith,” and a fourth account could be opened using the name and identity, “Debborah Johnson Smith.” In some instances, the person associated with the base name may not even be a real person and instead the identity was created using stolen or falsified documents. As such, the entity resolution process can use name matching techniques to detect fraudulent check activity associated with name variations to detect fraudulent activity and maintain consistency with check activity.

Based on such matching techniques, each retrieved name may be scored based on how closely it matches a name included in identification information associated with the inquiry. In some embodiments, each name component may be scored individually, with the individual component scores being combined to generate a match score. For example, an exact match of a given original name component may receive a maximum score, while a match of a standardized component, abbreviated form, encoded form, and/or concatenated form may result in a high, but not maximum score. Each non-original form may be associated with a certainty factor associated with a type of the form that is multiplied to the component score to generate a weighted score. For example, a single-letter abbreviation may have a low certainty factor (such as 0.3), indicating that there is a high degree of uncertainty that the abbreviation (such as “J” for Johnson) corresponds to the intended name match, while the use of an alternate form of a name (such as Susan for Sue) may include a higher certainty factor (such as 0.6). The scores for each name component may be aggregated (such as by summing the weighted scores) to generate an overall name score. Non-name identifiers may be similarly scored, with exact matches getting maximum scores, close matches (such as within one digit) may have moderate scores, and/or larger deviations having low or zero scores. The scores may be weighted and/or added to generate an overall account score.

Once the account score is generated for each result of the candidate search, the overall scores may be compared to a cutoff threshold score to identify matches that are highly likely to belong to the person associated with the inquiry. In some embodiments, the entries having scores at or above the threshold score may be analyzed to see if the records meet minimum requirements for a match. For example, a predetermined number of identifiers (such as 3 identifiers) may need to be present in each result. If only the account owner name (or other non-unique identifier) matches the person associated with the inquiry, the result may be thrown out due to the uncertainty of the match. If one or more unique identifiers match between a result and the person associated with the inquiry, the result may be included as a match. At operation 312, account data and/or transaction data associated with one or more accounts of the payee and/or account holder may be retrieved as detailed with respect to process 200 described above.

This entity resolution process provides a technological improvement to the functioning of the databases 108 by optimizing the candidate search operation. Storing and querying unstructured, raw alphanumeric strings (e.g., variations of human names with inconsistent spacing, punctuation, or middle initials) requires high CPU utilization and extensive memory allocation during database lookup operations. By systematically parsing, removing common address words, and splitting the raw string data into standardized tokens of a predefined length, the risk assessment system 104 creates a highly structured data format. This tokenization acts as a computationally efficient indexing mechanism that normalizes the data prior to execution of the search.

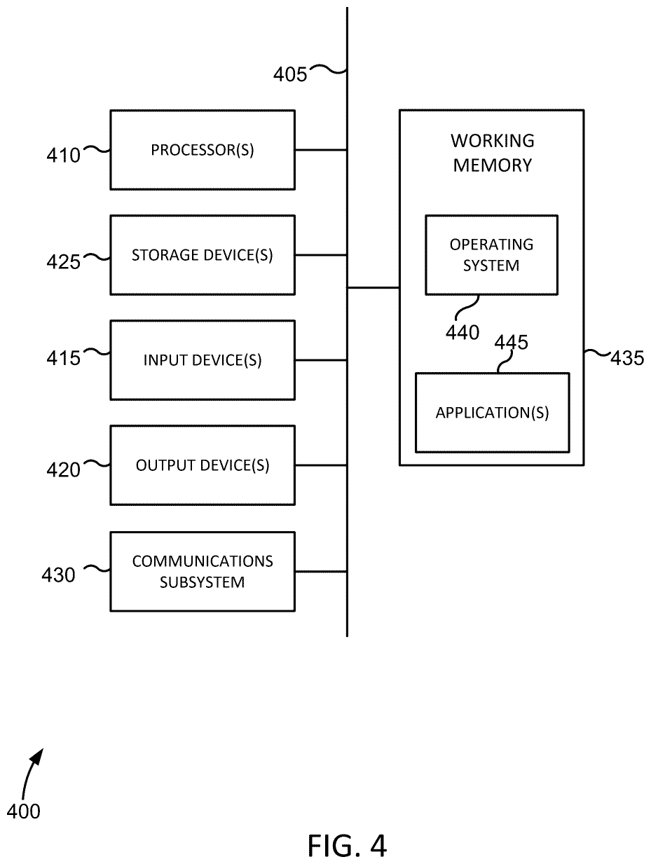

A computer system as illustrated in may be incorporated as part of the previously described computerized devices. For example, computer system 400 can represent some of the components of computing devices, such as the financial institutions 102, risk assessment system 104, databases 108, and/or other computing devices described herein. FIG. 4 provides a schematic illustration of one embodiment of a computer system 400 that can perform the methods provided by various other embodiments, as described herein. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include a processing unit 410, including without limitation one or more processors, such as one or more central processing units (CPUs), graphical processing units (GPUs), special-purpose processors (such as digital signal processing chips, graphics acceleration processors, and/or the like); one or more input devices 415, which can include without limitation a keyboard, a touchscreen, receiver, a motion sensor, a camera, a smartcard reader, a contactless media reader, and/or the like; and one or more output devices 420, which can include without limitation a display device, a speaker, a printer, a writing module, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communication interface 430, which can include without limitation a modem, a network card (wireless or wired), an infrared communication device, a wireless communication device and/or chipset (such as a Bluetooth™ device, a 502.11 device, a Wi-Fi device, a WiMAX device, an NFC device, cellular communication facilities, etc.), and/or similar communication interfaces. The communication interface 430 may permit data to be exchanged with a network (such as the network described below, to name one example), other computer systems, and/or any other devices described herein. In many embodiments, the computer system 400 will further comprise a non-transitory working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 410, applications 445, etc.) Further, connection to other computing devices such as network input/output devices may be employed.

Some embodiments may employ a computer system (such as the computer system 400) to perform methods in accordance with the disclosure. For example, some or all of the procedures of the described methods may be performed by the computer system 400 in response to processing unit 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the storage device(s) 425. Merely by way of example, execution of the sequences of instructions contained in the working memory 435 might cause the processing unit 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processing unit 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 425. Volatile media include, without limitation, dynamic memory, such as the working memory 435. Transmission media include, without limitation, coaxial cables, copper wire, and fiber optics, including the wires that comprise the bus 405, as well as the various components of the communication interface 430 (and/or the media by which the communication interface 430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 430 (and/or components thereof) generally will receive the signals, and the bus 405 then might carry the signals (and/or the data, instructions, etc. carried by the signals) to the working memory 435, from which the processor(s) 410 retrieves and executes the instructions. The instructions received by the working memory 435 may optionally be stored on a non-transitory storage device 425 either before or after execution by the processing unit 410.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

As defined herein, real-time, can in some embodiments, be defined with respect to operations carried out as soon as practically possible upon the occurrence of a triggering event. A triggering event can include receipt of data necessary to execute a task or to otherwise process information. Due to delays that are inherent in data transmission and/or in computing speeds, the term real-time encompasses operations that occur in “near” real-time or somewhat delayed from a triggering event. In a number of embodiments, real-time can mean real-time less a time delay for processing (e.g., determining) and/or transmitting data. The particular time delay can vary depending on the type and/or amount of the data, the processing speeds of the hardware, the transmission capability of the communication hardware, the transmission distance, and the like. However, in many embodiments, the time delay can be less than approximately one second, five seconds, ten seconds, thirty seconds, one minute, or five minutes.

As defined herein, batch mode, can in some embodiments, be defined with respect to operations carried out at a scheduled time interval upon the occurrence of a triggering event. A triggering event can include receipt of data necessary to execute a task or to otherwise process information. The particular scheduled time interval can vary depending on the type and/or amount of the data. However, in many embodiments, the scheduled time interval for the batch mode can be less than approximately 30 minutes, 1 hour, 3 hours, 6, hours, 12, hours, or 24 hours.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A risk assessment system, comprising:
one or more processors; and
a memory having instructions stored thereon that, when executed by the one or more processors, cause the one or more processors to:
receive check information associated with a treasury check from a receiving institution, wherein the check information comprises a first payee name printed on the treasury check, a check number of the treasury check, an amount of the treasury check, and a routing number of the treasury check;
send at least a portion of the check information to an issuing treasury institution;
receive, from the issuing treasury institution, a second payee name, wherein the second payee name was printed on the treasury check issued by the issuing treasury institution;
determine whether the treasury check has already been redeemed at another financial institution; and
provide a response to the receiving institution, the response comprising one or both of the second payee name and an indication of whether the first payee name and the second payee name match.

2. The risk assessment system of claim 1, wherein the instructions further cause the one or more processors to:
perform a name matching process on the first payee name to identify whether the first payee name matches one or more other identities.

3. The risk assessment system of claim 2, wherein:
determining whether the treasury check has already been redeemed at another financial institution is based at least in part on a result of the name matching process.

4. The risk assessment system of claim 2, wherein the instructions further cause the one or more processors to:
provide an indication to the receiving institution whether the first payee name matches an account maintained at the receiving institution.

5. The risk assessment system of claim 1, wherein:
determining whether the treasury check has already been redeemed at another financial institution comprises determining that the treasury check has been previously submitted at another institution; and
the instructions further cause the one or more processors to send an alert to the receiving institution that indicates that the treasury check has been previously submitted at another institution.

6. The risk assessment system of claim 5, wherein:
determining that the treasury check has been previously submitted at another institution is based at least in part on one or both of the check number of the treasury check and the routing number of the treasury check.

7. The risk assessment system of claim 5, wherein the instructions further cause the one or more processors to:
alert at least one other institution that the treasury check has been previously submitted.

8. A method of assessing risk, comprising:
receiving, by a risk assessment system, check information associated with a treasury check from a receiving institution, wherein the check information comprises a first payee name printed on the treasury check, a check number of the treasury check, an amount of the treasury check, and a routing number of the treasury check;
sending, by the risk assessment system, at least a portion of the check information to an issuing treasury institution;
receiving, by the risk assessment system and from the issuing treasury institution, a second payee name, wherein the second payee name was printed on the treasury check issued by the issuing treasury institution;
determining whether the treasury check has already been redeemed at another financial institution; and
providing, by the risk assessment system, a response to the receiving institution, the response comprising one or both of the second payee name and an indication of whether the first payee name and the second payee name match.

9. The method of assessing risk of claim 8, wherein:
the receiving institution comprises a first receiving institution; and
the method comprises:
determining that the treasury check is fraudulent based on the first payee name and the second payee name being different;
receiving a check inquiry from a second receiving institution; and
providing a risk score to the second receiving institution, wherein the risk score is based at least in part on determining that the treasury check is fraudulent.

10. The method of assessing risk of claim 8, wherein:
the response comprises the indication of whether the first payee name and the second payee name match.

11. The method of assessing risk of claim 8, further comprising:
generating a risk score that is indicative of a level of risk associated with a given treasury check having the first payee name on a payee line of the given treasury check; and
sending the risk score to the receiving institution.

12. The method of assessing risk of claim 11, further comprising:
identifying a check history associated with the first payee name from one or more bank accounts, wherein the risk score is generated at least in part based on the check history.

13. The method of assessing risk of claim 11, wherein:
the risk score is provided to the receiving institution with the response.

14. The method of assessing risk of claim 11, wherein:
the risk score is based, at least in part, on whether prior checks having the first payee name on a payee line of each prior check have been deemed to be fraudulent.

15. A non-transitory computer-readable medium having instructions stored thereon that, when executed by one or more processors, cause the one or more processors to:
receive check information associated with a treasury check from a receiving institution, wherein the check information comprises a first payee name printed on the treasury check, a check number of the treasury check, an amount of the treasury check, and a routing number of the treasury check;
send at least a portion of the treasury check information to an issuing treasury institution;
receive, from the issuing treasury institution, a second payee name, wherein the second payee name was printed on the treasury check issued by the issuing treasury institution;
determine whether the treasury check has already been redeemed at another financial institution; and
provide a response to the receiving institution, the response comprising one or both of the second payee name and an indication of whether the first payee name and the second payee name match.

16. The non-transitory computer-readable medium of claim 15, wherein the instructions further cause the one or more processors to:
send a risk score to the receiving institution, wherein the risk score is indicative of a level of risk associated with a given treasury check having the first payee name on a payee line of the given treasury check.

17. The non-transitory computer-readable medium of claim 16, wherein:
the risk score is based, at least in part, on whether the first payee name is associated with a prior fraudulent treasury check.

18. The non-transitory computer-readable medium of claim 16, wherein:
the risk score is further indicative that the first payee name has been associated with passing a bad check.

19. The non-transitory computer-readable medium of claim 15, wherein:
the issuing treasury institution comprises the U.S. Treasury or a state treasury.

20. The non-transitory computer-readable medium of claim 15, wherein the instructions further cause the one or more processors to:
perform a name matching process on the first payee name;
identify one or more accounts associated with the first payee name based on a result of the name matching process;
generate a risk score that is indicative of a level of risk associated with a given treasury check having the first payee name on a payee line of the given treasury check based at least in part on the one or more accounts; and
send the risk score to the receiving institution.
